(19) United States
(12) Patent Application Publication
(10) Pub. No.: US 2011/0199633 A1
(43) Pub. Date: Aug. 18, 2011

(54) Halftone bit depth dependent digital image compression

(76) Inventor: Uoc H. Nguyen, Long Beach, CA (US)

(21) Appl. No.: 12/658,921

(22) Filed: Feb. 17, 2010

(51) Int. Cl. G06F 15/00; G06K 9/36

(52) U.S. Cl. 358/1.15; 382/232

(57) ABSTRACT

Image processing methods and systems wherein a compression strategy for a digital image is determined using a halftone bit depth. In one aspect of the invention, an imaging node comprises a processor, a storage element communicatively coupled with the processor and a print engine communicatively coupled with the processor, wherein under control of the processor the imaging node compresses a digital image in accordance with compression optimization information obtained using a halftone bit depth, stores the compressed digital image in the storage element, retrieves the compressed digital image from the storage element, decompresses the compressed digital image, color converts the decompressed digital image, halftones the color converted digital image and transmits the halftoned digital image to the print engine whereupon the digital image is printed.

### BACKGROUND OF INVENTION

The present invention relates to digital imaging and, more particularly, methods and systems for more efficiently compressing digital images.

Imaging nodes, such as multifunction peripheral (MFP) nodes, provide many types of imaging services, such as copying, faxing, filing, format conversion, printing and scanning. It is often desirable to maintain digital images in persistent storage in support of these imaging services. For example, it may be advantageous to commit a digital image from a copy job to persistent storage so that the image can be printed on multiple occasions without having to rescan the image, and it may be advantageous to commit a digital image from a print job to persistent storage so that the image can be printed on multiple occasions without having to re-perform raster image processing (RIP) on the image.

Before sending a digital image to persistent storage, some imaging nodes compress the image to reduce the memory required by the stored image as well as the bandwidth consumed when the image is transmitted. When compressing the image, these imaging nodes typically use a high image quality factor (Q-factor) to preserve the quality of the image to the extent possible. By way of example, a Q-factor of between 90 to 100 may be used and yield a compression ratio of between 8:1 and 10:1. At that compression ratio, a 600 dots per inch (DPI) red-green-blue (RGB) image file that is 96 megabytes before compression will be reduced to a compressed image file sized between 9.6 and 12 megabytes.

When the digital image is thereafter printed, the image is retrieved from persistent storage, decompressed, color converted and halftoned to generate a print engine-ready image. Halftoning converts the image from 8 bits per color to either 4 bits, 2 bits or 1 bit per color, depending on print settings. 4-bit halftoning may be used where high print quality is needed; 2-bit halftoning may be used to achieve modest print quality; and 1-bit halftoning may be used where low print quality will suffice.

In many printing environments, 1-bit halftone print jobs are predominant. 1-bit halftoning can degrade the quality of a printed image to an extent that the benefit of having used a high Q-factor to preserve the quality of the digital image during compression is largely or entirely lost. Thus, in these printing environments, most images are not efficiently compressed and consume an inordinate amount of memory and bandwidth, hindering system performance. Even in printing environments where 2-bit halftoning predominates, the benefits of using a high Q-factor may be outweighed by the costs for similar reasons.

### SUMMARY OF THE INVENTION

The present invention, in a basic feature, provides image processing methods and systems in which a compression strategy for a digital image is determined using a halftone bit depth.

In one aspect of the invention, an imaging node comprises a processor and a first storage element communicatively coupled with the processor, wherein under control of the processor the imaging node compresses a digital image in accordance with compression optimization information retrieved from the first storage element using a halftone bit depth.

In some embodiments, the compression optimization information comprises an image quality factor (Q-factor).

In some embodiments, the compression optimization information comprises a compression ratio.

In some embodiments, the imaging node further comprises a second storage element and a print engine, and under control of the processor the imaging node stores the compressed digital image in the second storage element, retrieves the compressed digital image from the second storage element, decompresses the compressed digital image, color converts the decompressed digital image, halftones the color converted digital image and transmits the halftoned digital image to the print engine whereupon the digital image is printed.

In some embodiments, the first storage element comprises a compression optimization map having plurality of entries each associating a different halftone bit depth with compression optimization information and under control of the processor the imaging node retrieves compression optimization information from one of the entries using a halftone bit depth as a lookup key.

In some embodiments, the imaging node further comprises a user interface communicatively coupled with the processor, and under control of the processor the imaging node updates the compression optimization map based at least in part on update information received via the user interface.

In some embodiments, the imaging node further comprises a network interface communicatively coupled with the processor, and under control of the processor the imaging node updates the compression optimization map based at least in part on update information received via the network interface.

In some embodiments, the imaging node further comprises a user interface communicatively coupled with the processor, and under control of the processor the imaging node determines the halftone bit depth based at least in part on print setting information received via the user interface.

In some embodiments, the imaging node further comprises a network interface communicatively coupled with the processor, and under control of the processor the imaging node determines the halftone bit depth based at least in part on print setting information received via the network interface.

In some embodiments, under control of the processor the imaging node determines the halftone bit depth based at least in part on halftone bit depths applied to other digital images printed by the imaging node.

In some embodiments, the halftone bit depth is selected from the group consisting of 1 bit, 2 bits or 4 bits.

In another aspect of the invention, an imaging node comprises a processor, a storage element communicatively coupled with the processor and a print engine communicatively coupled with the processor, wherein under control of the processor the imaging node compresses a digital image in accordance with compression optimization information obtained using a halftone bit depth, stores the compressed digital image in the storage element, retrieves the compressed digital image from the storage element, decompresses the compressed digital image, color converts the decompressed digital image, halftones the color converted digital image and transmits the halftoned digital image to the print engine whereupon the digital image is printed.

In yet another aspect of the invention, a method for processing a digital image comprises the steps of compressing by an imaging node a digital image in accordance with compression optimization information obtained using a halftone bit depth, storing by the imaging node the compressed digital image, retrieving from storage by the imaging node the compressed digital image, decompressing by the imaging node the compressed digital image, color converting by the imaging node the decompressed digital image, halftoning by the imaging node the color converted digital image and printing by the imaging node the halftoned digital image.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the invention is operative in some embodiments.

FIG. 2 shows an imaging node in some embodiments of the invention.

FIG. 3 shows an image processing pipeline on an imaging node in some embodiments of the invention.

FIG. 4 shows a compression map store access regimen on an imaging node in some embodiments of the invention.

FIG. 5 shows a compression optimization map on an imaging node in some embodiments of the invention.

FIG. 6 shows a method for processing a digital image on an imaging node in some embodiments of the invention.

### DETAILED DESCRIPTION OF A PREFERRED EMBODIMENT

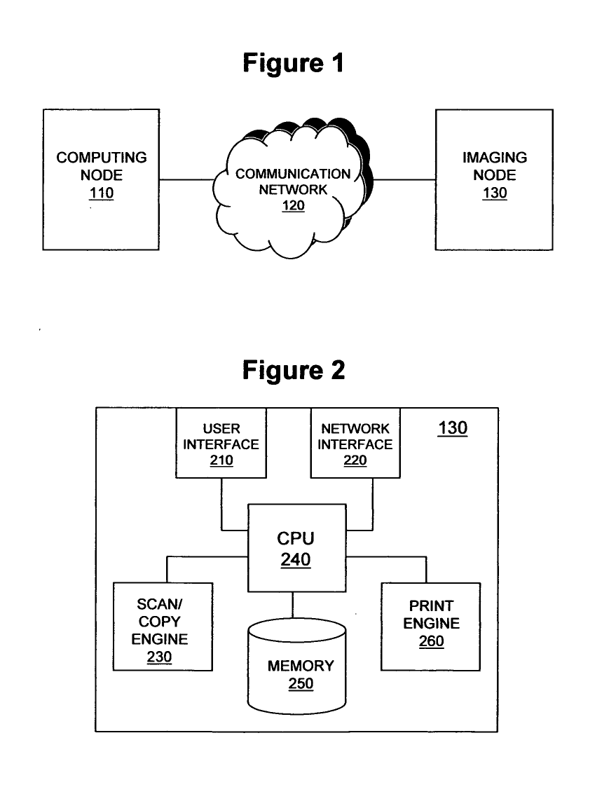

FIG. 1 shows a communication system in which the invention is operative in some embodiments. The system includes a computing node 110 and an imaging node 130 communicatively coupled over a communication network 120. While one computing node 110 is shown, a communication system within the scope of the invention may have a different number of computing nodes.

Computing node 110 is a data communication device that has client software for initiating and transmitting imaging jobs. Computing node 110 may be a personal computer, personal data assistant (PDA), smart phone, cell phone or Internet appliance, by way of example. Computing node 110 transmits via a wired or wireless network interface on computing node 110 imaging jobs initiated by a user through inputs on a user interface of computing node 110. Imaging jobs may be sent directly to imaging node 130 or may be first preprocessed by an imaging job server node within communication network 120 that, for example, identifies imaging node 130 as a destination for the imaging job and converts the imaging job into a format compatible with imaging node 130.

Communication network 120 is a data communication network that communicatively couples computing node 110 and imaging node 130. Communication network 120 may include one or more wired or wireless local area network (LAN), wide area network (WAN), World Interoperability for Microwave Access (WiMAX), cellular network, ad-hoc and/or other network nodes to facilitate communicative coupling. Alternatively, computing node 110 and imaging node 130 may be communicatively coupled over a direct wired or wireless link, such as a Universal Serial Bus (USB), Institute of Electrical and Electronics Engineers (IEEE) 1394 (Firewire), IEEE 802.3 (Ethernet), IEEE 802.11 (WiFi), Bluetooth or Infrared Data Association (IrDa) connection.

Communication network 120 may also include an update server node that has server software for updating software and device settings on imaging node 130. Such updates may be transmitted via a wired or wireless network interface on the update server node.

Turning to FIG. 2, imaging node 130 is shown in more detail in some embodiments of the invention. Imaging node 130 is a multifunction peripheral (MFP) node that provides multiple types of imaging services, such as copying, faxing, filing, format conversion, printing and scanning. Imaging node 130 has a user interface 210 for receiving input from walk-up users. Imaging node 130 has a wired and/or wireless network interface 220, such as a USB, Firewire, Ethernet, WiFi, Bluetooth or IrDa interface, that communicatively couples imaging node 130 to communication network 120 and, in some embodiments, to peripheral devices (e.g. USB thumb drive, external hard drive, etc.). Network interface 220 may have multiple ports, and those multiple ports may support the same or different data communication protocols.

Imaging node 130 receives via user interface 210 and/or network interface 220 imaging jobs, such as copy jobs, fax jobs, filing jobs, format conversion jobs, print jobs and scan jobs, and processes those imaging jobs. Imaging jobs address content (e.g. documents, photographs, etc.) and may be accompanied by a digital image of the content, a reference to a location of a digital image of the content or a hard copy of the content to be digitally imaged. Imaging jobs may also be accompanied by print settings, including a halftone bit depth print setting that indicates a halftone bit depth to be used when printing the digital image on imaging node 130.

Imaging node 130 may also receive via user interface 210 (e.g. from a walk-up user) and/or network interface 220 (e.g. from a user of computing device 110 or an update server node) device settings updates, such as a compression optimization map update that specifies operative relationships between halftone bit depths and compression optimization information, such as image quality factors (Q-factors) or compression ratios.

Internal to imaging node 130, user interface 210, network interface 220, a scan/copy engine 230, a memory 250 and a print engine 260 are communicatively coupled with a processor (CPU) 240.

Scan/copy engine 230 includes scanner/copier logic, such as one or more integrated circuits (ICs), and a mechanical section for performing scanning and copying functions. Scan/copy engine 230 may, for example, have a line image sensor mounted on a movable carriage for optically scanning under the control of a scanner IC a digital image placed on exposure glass of imaging node 130.

Memory 250 has a first storage element for storing a compression optimization map having entries that associate different halftone bit depths with compression optimization information, such as Q-factors or compression ratios. Memory 250 has a second storage element for persistently storing compressed digital images. The second storage element may be an electronic recirculating document handler (ERDH) storage element, by way of example. In other embodiments, storage facilities for storing a compression optimization map and/or compressed digital images may reside outside of imaging node 130.

Print engine 260 includes printer logic, such as one or more printer ICs, and a mechanical section, such as a color ink jet head mounted on a movable carriage or a toner powder fusing system, for outputting digital images in hard copy format under control of the one or more printer ICs.

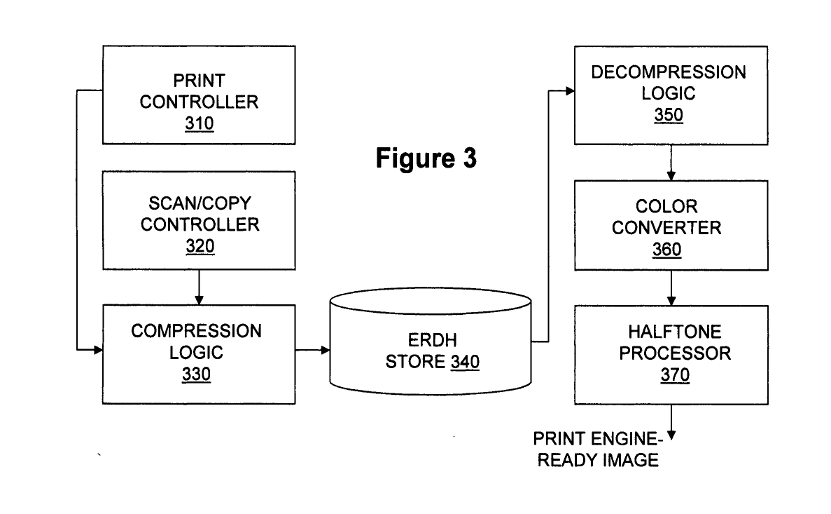

FIG. 3 shows an image processing pipeline on imaging node 130 in some embodiments of the invention. The image processing pipeline includes a print controller 310 and a scan/copy controller 320 that are operatively coupled with compression logic 330. Compression logic 330 has access to an ERDH store 340. Also having access to ERDH store 340 is decompression logic 350, which is operatively coupled with a color converter 360 that is in turn operatively coupled with a halftone processor 370. Print controller 310, scan/copy controller 320, compression logic 330, color converter 360 and halftone processor 370 may be implemented in software executable by processor 240, and ERDH store 340 may reside in memory 250, although in other embodiments one or more of these elements may reside outside of imaging node 130. Purely by way of example, ERDH store 340 may reside on an external hard drive, database server node, storage server node or removable storage element to which imaging node 130 has access.

Print controller 310 is invoked in service of print jobs received on user interface 210 and/or network interface 220. Print controller 310 receives as input print job content, such as a pre-raster image processing (pre-RIP) digital image, and outputs to compression logic 330 a continuous tone (contone) formatted digital image, such as a red-green-blue (RGB) 8-bit per pixel digital image. A pre-RIP digital image may be in a page description language (PDL) format, such as a Printer Command Language 5c (PCL5c), PCL Level 6 (PCLXL), PostScript or Portable Document Format (PDF). A print job received by print controller 310 may contain the digital image or a reference to a location where the digital image resides. In the latter case, the print job may include a Uniform Resource Locator (URL), Uniform Resource Identifier (URI) or a network file path to the digital image and print controller 310 may retrieve the digital image using the reference.

Scan/copy controller 320 is invoked in service of copy jobs received on user interface 210 and network interface 220. Scan/copy controller 320 receives as input copy job content, such as a digital image generated by optically scanning a printed image placed on exposure glass of imaging node 130, and outputs to compression logic 330 a contone digital image, such as a RGB 8-bit per pixel digital image. As an alternative to a digital image generated by optically scanning a printed image placed on exposure glass of imaging node 130, copy job content may be a digital image accompanying an inbound fax, for example.

When compression logic 330 receives a digital image from print controller 310 or scan/copy controller 320, compression logic 330 compresses the digital image in accordance with compression optimization information. Compression optimization information is determined using a halftone bit depth applicable to the digital image, as will be explained. The Joint Photographic Experts Group (JPEG) compression algorithm may be invoked as the compression algorithm, by way of example.

The compressed digital image is then committed to memory in ERDH store 340, wherein the digital image is persistently stored to expedite printing of subsequent copy or print jobs addressing the same content. The digital image may be stored in association with attributes of the copy or print job or the job content (e.g. name, date, size, checksum) to facilitate later retrieval of the digital image from ERDH store 340. Persistently storing the compressed digital image can yield printing efficiencies. For example, a digital image from a copy job can be printed on later occasions without having to rescan the image, and a digital image from a print job can be printed on later occasions without having to re-perform raster image processing (RIP) on the image.

When a subsequent copy or print job is received addressing content for which a digital image is already stored in ERDH store 340, the digital image is retrieved from ERDH store 340 and outputted to decompression logic 350. Decompression logic 350 decompresses the digital image and outputs the digital image to color converter 360. Decompression logic 350 may invoke JPEG decompression, by way of example.

Color converter 360 converts the digital image received from decompression logic 350 into a cyan-magenta-yellow-black (CYMK) 8-bit per color digital image and outputs the CYMK 8-bit per color digital image to halftone processor 370.

Halftone processor 370 halftones the CYMK 8-bit per color digital image received from color converter 360 into a 4 bit, 2 bit or 1 bit per color digital image depending on a halftone bit depth applicable to the digital image and outputs the print engine-ready image to print engine 260, which outputs the digital image in hard copy format.

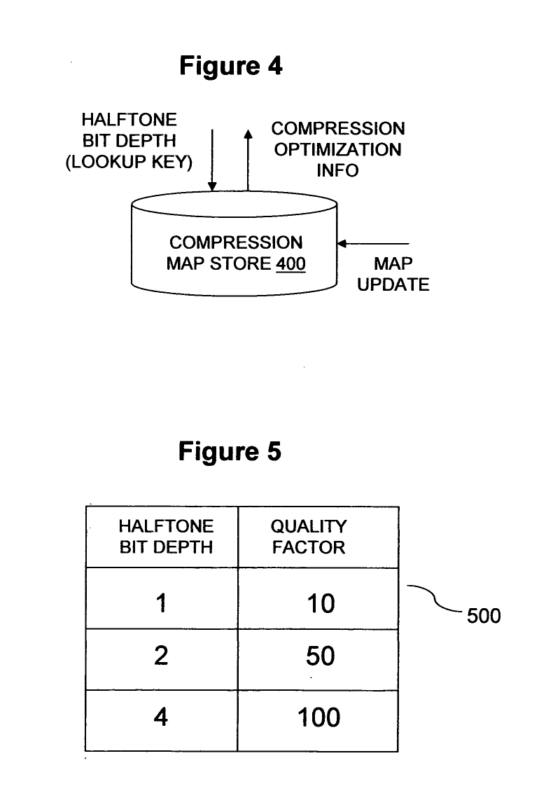

As mentioned above, compression logic 330 compresses the digital image in accordance with compression optimization information determined using a halftone bit depth applicable to the digital image. FIG. 4 shows how compression optimization information is determined in some embodiments of the invention. A compression map store 400 has a compression optimization map with plurality of entries each associating a different halftone bit depth with compression optimization information. Under control of processor 240, imaging node 130 retrieves compression optimization information from one of the entries using a halftone bit depth applicable to the digital image as a lookup key. The lookup operation may be performed by compression logic 330. Alternatively, the lookup operation may be performed by one of controllers 310, 320 or another image processing element that passes the compression optimization information to compression logic 330. Compression map store 400 may be implemented in memory 250 or an external storage facility.

The halftone bit depth applicable to the digital image may be determined in various ways. By way of example, the halftone bit depth may be specified in a print setting for the copy or print job addressing the digital image. Such a print setting may be a default setting, a setting selected by a user on user interface 210, or a setting selected by a user on computing node 110 and received via network interface 220. Alternatively, the halftone bit depth may be independently determined by imaging node 130 based on halftone bit depths applied to other digital images printed by imaging node 130. For example, processor 240 may record in memory 250 halftone bit depths applied to other digital images printed by imaging node 130 and adopt the most frequently used or the most recently used halftone bit depth as a lookup key. Alternatively, imaging node 130 may adopt as a lookup key a default halftone bit depth configured in device settings stored in memory 250. The halftone bit depth applied by halftone processor 370 to the digital image attendant to servicing the subsequent copy or print job may be determined by similar means.

FIG. 5 shows a compression optimization map 500 in some embodiments of the invention. In these embodiments, the compression optimization information is a Q-factor. Compression optimization map 500 has entries associating different halftone bit depths with Q-factors. In the illustrated example, compression optimization map 500 includes three entries. In a first entry, a halftone bit depth of 1 bit per color is associated with a Q-factor of 10 (low image quality preservation). In a second entry, a halftone bit depth of 2 bits per color is associated with a Q-factor of 50 (average image quality preservation). In a third entry, a halftone bit depth of 4 bits per color is associated with a Q-factor of 100 (full image quality preservation). To determine compression optimization information applicable to the digital image, imaging node 130 under control of processor 240 searches compression optimization map 500 and locates an entry that has a halftone bit depth matching the halftone bit depth lookup key and retrieves the corresponding Q-factor. Naturally, the specific Q-factor values shown in FIG. 5 are merely exemplary. Moreover, a compression optimization parameter other than Q-factor, such as compression ratio, may be used.

Compression optimization map 500 may be populated in various ways. In some embodiments, compression optimization map 500 is initially populated by the manufacturer of imaging node 130 with default entries selected based on an image quality study performed by the manufacturer. For example, for each halftone bit depth, the manufacturer may test various Q-factors to generate a printed suite and visually inspect the printed suite to determine an optimal Q-factor for each halftone bit depth. Compression optimization map 500 may thereafter be updated after installation, as illustrated in FIG. 4, through inputs by a user on user interface 210, inputs by a user on computing node 110 received via network interface 220, or updates sourced by an update server node in communication network 120 and received via network interface 220.

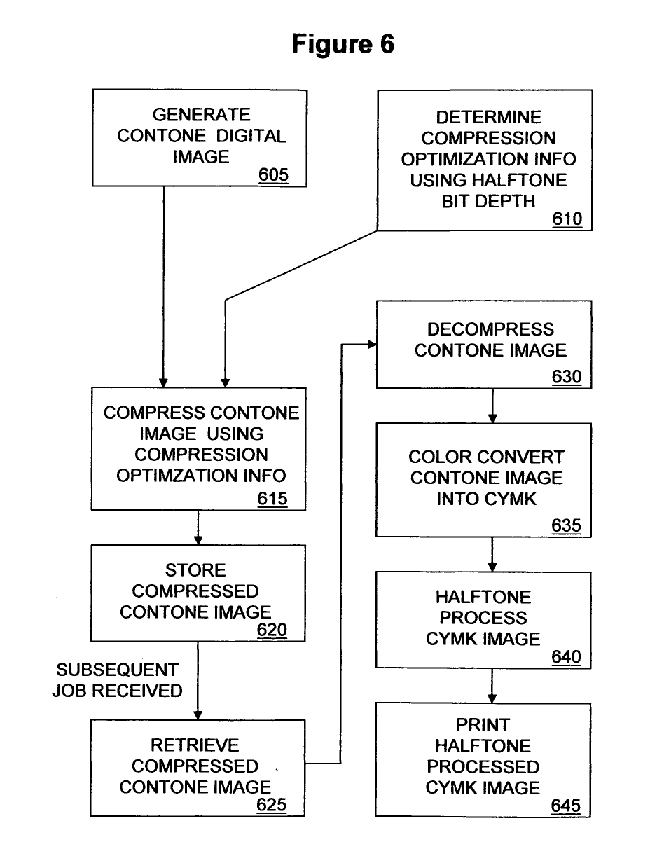

FIG. 6 shows a method for processing a digital image on an imaging node under control of processor 240 in some embodiments of the invention. A contone formatted digital image for a copy or print job is generated (605) and compression optimization information (e.g. Q-factor) for the digital image is determined using a halftone bit depth applicable to the digital image (610). The digital image is compressed using the compression optimization information (615) and committed to memory 250 wherein the digital image is persistently stored (620). A subsequent copy or print job addressing the digital image is thereafter received, whereupon the digital image is retrieved from memory 250 (625) and decompressed (630), after which the digital image is converted into a CYMK 8-bit per color digital image (635). The digital image is then halftoned using a halftone bit depth applicable to the digital image (640) and printed (645).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. An imaging node, comprising:
a processor; and
a first storage element communicatively coupled with the processor, wherein under control of the processor the imaging node compresses a digital image in accordance with compression optimization information retrieved from the first storage element using a halftone bit depth.

2. The imaging node of claim 1, wherein the compression optimization information comprises an image quality factor (Q-factor).

3. The imaging node of claim 1, wherein the compression optimization information comprises a compression ratio.

4. The imaging node of claim 1, further comprising a second storage element and a print engine, wherein under control of the processor the imaging node stores the compressed digital image in the second storage element, retrieves the compressed digital image from the second storage element, decompresses the compressed digital image, color converts the decompressed digital image, halftones the color converted digital image and transmits the halftoned digital image to the print engine whereupon the digital image is printed.

5. The imaging node of claim 1, wherein the first storage element comprises a compression optimization map having plurality of entries each associating a different halftone bit depth with compression optimization information and under control of the processor the imaging node retrieves compression optimization information from one of the entries using the halftone bit depth as a lookup key.

6. The imaging node of claim 5, further comprising a user interface communicatively coupled with the processor, wherein under control of the processor the imaging node updates the compression optimization map based at least in part on update information received via the user interface.

7. The imaging node of claim 5, further comprising a network interface communicatively coupled with the processor, wherein under control of the processor the imaging node updates the compression optimization map based at least in part on update information received via the network interface.

8. The imaging node of claim 1, further comprising a user interface communicatively coupled with the processor, wherein under control of the processor the imaging node determines the halftone bit depth based at least in part on print setting information received via the user interface.

9. The imaging node of claim 1, further comprising a network interface communicatively coupled with the processor, wherein under control of the processor the imaging node determines the halftone bit depth based at least in part on print setting information received via the network interface.

10. The imaging node of claim 1, wherein under control of the processor the imaging node determines the halftone bit depth based at least in part on halftone bit depths applied to other digital images printed by the imaging node.

11. The imaging node of claim 1, wherein the halftone bit depth is selected from the group consisting of 1 bit, 2 bits or 4 bits.

12. An imaging node, comprising:
a processor;
a storage element communicatively coupled with the processor; and
a print engine communicatively coupled with the processor, wherein under control of the processor the imaging node compresses a digital image in accordance with compression optimization information obtained using a halftone bit depth, stores the compressed digital image in the storage element, retrieves the compressed digital image from the storage element, decompresses the compressed digital image, color converts the decompressed digital image, halftones the color converted digital image and transmits the halftoned digital image to the print engine whereupon the digital image is printed.

13. The imaging node of claim 12, wherein the compression optimization information comprises a Q-factor.

14. The imaging node of claim 12, wherein the compression optimization information comprises a compression ratio.

15. The imaging node of claim 12, further comprising a user interface communicatively coupled with the processor, wherein under control of the processor the imaging node determines the halftone bit depth based at least in part on print setting information received via the user interface.

16. The imaging node of claim 12, further comprising a network interface communicatively coupled with the processor, wherein under control of the processor the imaging node determines the halftone bit depth based at least in part on print setting information received via the network interface.

17. The imaging node of claim 12, wherein under control of the processor the imaging node determines the halftone bit depth based at least in part on halftone bit depths applied to other digital images processed by the imaging node.

18. A method for processing a digital image, comprising the steps of:
compressing by an imaging node a digital image in accordance with compression optimization information obtained using a halftone bit depth;
storing by the imaging node the compressed digital image;
retrieving from storage by the imaging node the compressed digital image;
decompressing by the imaging node the compressed digital image;
color converting by the imaging node the decompressed digital image;
halftoning by the imaging node the color converted digital image; and
printing by the imaging node the halftoned digital image.

19. The method of claim 18, wherein the compression optimization information comprises a Q-factor.

20. The method of claim 18, wherein the compression optimization information is obtained from a compression optimization map having plurality of entries each associating a different halftone bit depth with compression optimization information using the halftone bit depth as a lookup key.
